(19) United States
(12) Patent Application Publication
(10) Pub. No.: US 2004/0046938 A1
(43) Pub. Date: Mar. 11, 2004

(54) Automatic and manual lens focusing system with visual matching for motion picture camera

(76) Inventor: Gary Gero, Friday Harbor, WA (US)

Correspondence Address: FRELING E. BAKER, BROWN MARTIN HALLER & MCCLAIM, 1660 UNION STREET, SAN DIEGO, CA, 92101, US

(21) Appl. No.: 10/235,407

(22) Filed: Sep. 5, 2002

(51) Int. Cl. G03B 3/00

(52) U.S. Cl. 352/140

(57) ABSTRACT

An automatic lens focusing system according to the present invention includes an adjustable focus lens having a driver for focusing the lens on a photographic subject, a lens position detecting device to detect a focus position of the lens, a distance detecting device to detect a subject distance from the lens and generate a range signal representation of the range to the photographic subject, automatic actuating device responsive to the range signal for activating the driver to adjust the position of the lens to focus on the photographic subject, an indicating device responsive to the range signal for activating a first indicator indicative of the focal point of the subject and responsive to the lens setting for activating a second indicator indicative of the range setting of the lens, a manual actuator responsive to a manual input to for activating the driver to focus the lens, and a switching device to switch between the automatic mode and the manual mode.

### BACKGROUND OF THE INVENTION

The present invention relates to a lens focusing systems for motion picture cameras having selectively automatic and manual modes and is particularly directed to a system for selectively automatically or manually focusing a movie camera with visual range and focus indicators available for matching in the manual mode.

The commercial production of motion pictures requires the proper focusing of a camera during filming. In most instances this means a sharply focused image, whereas in other it may mean a fuzzy image. In the production of realistic, commercially valuable films, sharpness of focus is ordinarily an important consideration. Maintenance of a sharply focused image of the principal object of interest in a given scene, particularly when the principal object is moving toward or away from the camera, is particularly challenging in cinematography. The depth of field is an important concept in the focusing of a camera. Depth of field is a description of the range of distances an object of interest can be from the camera and remain in acceptably sharp focus without adjustment of the camera lens. Depth of field becomes smaller with increasing lens focal length, with larger lens aperture and with decreasing object distance to the camera. In commercial camera work, whether with film or video cameras, a tendency toward long focal length lenses operated with large aperture puts narrow limits on depth of field in usual practice and, accordingly, on the demands for precise adjustment of the focus of the lens. Under these conditions it is essential that the lens be focused accurately to obtain an acceptably sharp image.

Many attempts have been made over the years to develop automatic focusing systems for movie cameras that would overcome the above deficiencies of the earlier focusing systems. These prior art proposals have included ultrasonic ranging systems which have an ultrasonic transmitter for transmitting an ultrasonic acoustic pulse and a receiver for receiving a reflected pulse from the target and producing a signal indicative of the range and utilizing the signal for varying the focus of the lens. Such systems operate satisfactorily with a single moving target, but present problems when there are multiple targets or when multiple moving targets or objects surround the principle target.

Other systems have utilized light beams such as infrared light beams and the like for the generated signal. These systems suffer from the same problem as the ultrasonic systems in that target discrimination becomes a problem when multiple targets are within the scene of the principle target. One system employed is that of a light system which employs two small mirrors on either side of a prism, one of which is fixed at a preset angle to the prism and the other which vibrates to scan the scene. A small microprocessor measures the angle of the scanning mirror when the images coincide to calculate the camera-to-subject distance and sends a signal to a focusing motor which adjusts the lens accordingly.

The applicant and his co-inventor developed an automatic focusing system disclosed in U.S. Pat. No. 4,534,629, entitled Motion Picture Camera Automatic Focusing System, issued to Robert W. Bogle and Gary Gero on Aug. 13, 1985, and U.S. Pat. No. 4,601,557, entitled Motion Picture Camera Automatic Focusing System, issued to Robert W. Bogle and Gary Gero on Jul. 22, 1986 which overcame many of the problems of the prior art. These disclose an automatic focusing system for variable focus lens of a motion picture camera which includes a pulse modulator and a microwave transmitter which is mounted on a camera frame for generating a high frequency pulsed signal which is transmitted to a selected target which carries a reactive signal generator which is responsive to the first signal for coding and retransmitting the coded signal back to a receiver which is mounted on the camera frame, a signal processor for determining the interval of travel of the signal and translating the interval into a distance-analog signal that is transmitted to a focusing motor for driving the focusing mechanism of the lens for focusing the lens at the distance which is determined by the signal. The automatic focusing system is either incorporated in or mounted on the housing of the motion picture camera.

This automatic focusing system works very well for most applications. However, the applicant discovered that many professional camera operators want more control over the focusing of the camera lens. For example, in some situations, it is desirable to fade into or out of focus on a subject or a scene. In other situations it may be desirable to hold a scene or subject slightly out of focus for a predetermined period of time. The applicant has provided and experimented with a system to give the operator the option to move to manual focusing using the radar as a range finder giving a numerical representation when a shot required a focal setting slightly different than the actual range. It became apparent after some experimentation that using numerical matching of the radar range and the lens setting was not the best solution.

It is therefore desirable that a camera focusing system be available which is selectively automatic or manual with visual representation of object and lens focus available to the operator in the manual range to enable close matching when desirable.

The present system employs means for more particularly discriminating selected objects or targets within a scene to be photographed in an automatic mode and providing visual representation of object range and focal setting in a manual mode to enable selective matching of lens focus and object range.

### SUMMARY AND OBJECTS OF THE INVENTION

It is the primary object of the present invention to provide a camera focusing system which is selectively automatic or manual with visual representation of object and lens focus available to the operator in the manual range to enable precise focusing or close matching as desired.

In accordance with a primary aspect of the present invention, an automatic lens focusing system according to the present invention includes a first radio signal generating and transmitting unit carried by the camera to be focused for generating and transmitting an adjustable focus lens having a driver for focusing the lens on a photographic subject, a lens position detecting device to detect a focus position of the lens, a distance detecting device to detect a subject distance from the lens and generate a range signal representation of the range to the photographic subject, automatic actuating means responsive to the range signal for activating the driver to adjust the position of the lens to focus on the photographic subject, an indicating device responsive to said range signal for activating a first indicator indicative of the focal point of said subject and responsive to the lens setting for activating a second indicator indicative of the range setting of the lens, manual actuating means responsive a manual input to for activating the driver to focus the lens, and a switching device to switch between the automatic mode and the manual mode.

### BRIEF DESCRIPTION OF THE DRAWINGS

The nature, goals, and advantages of the invention will become more apparent to those skilled in the art after considering the following detailed description when read in connection with the accompanying drawing, illustrating by way of examples the principles of the invention, in which like reference numerals identify like elements throughout wherein:

FIG. 1 illustrates the use of a motion picture camera embodying the focusing system and method of the present invention.

FIG. 2 is a general block diagram of the overall system of the present invention.

FIG. 3 is a detailed block diagram of one preferred embodiment of the present invention.

FIG. 4 is a detailed block diagram of an alternative preferred embodiment of the system of the present invention.

It will be recognized that some or all of the Figures are schematic representations for purposes of illustration and do not necessarily depict the actual relative sizes or locations of the elements shown.

### DETAILED DESCRIPTION OF THE PREFERRED EMBODIMENTS

In the following paragraphs, the present invention will be described in detail by way of example with reference to the attached drawings. In the description, the parts and components of the present invention which are the same will be referred to by the same or similar reference symbols.

Definitions

Unless defined otherwise, all technical and scientific terms used herein have the same meaning as is commonly understood by one of skill in the art to which this invention belongs. In event the definition in this section is not consistent with definitions elsewhere, the definitions set forth in this section will control.

As used herein, movie or motion picture camera refers to a camera capable of taking and recording scenes with moving subjects or objects and recording it on any medium whether film, tape, mag card, CD or any other recording medium.

As used herein, focusing of a lens means any form of changing the lens setting to focus on a subject whether optical, digital or other.

General

Throughout this description, the preferred embodiment and examples shown should be considered as exemplars, rather than as limitations on the present invention.

As shown in FIG. 1 of the drawing for purposes of illustration, a motion picture camera designated generally at 10 is embodied within a housing 11 and has a lens assembly or system 12 focused on and filming a scene with a couple of subjects or characters 13 and 14. The camera has a traditional viewfinder 15 and also preferably has a screen 16 as is customary in many current models for framing the subjects. The screen is typically on the left side of the camera but may be on either side. The lens focusing system has both an automatic mode and a manual mode with a rangefinder 17 providing a signal for automatic focusing and for an indicator to provide a visual indication of range to the operator. The focal setting of the lens provides a signal to the automatic focusing system and also provides a signal to an indicator that provides a visual indication of the focal setting to the operator. The indication of range and the indication of the focal setting are preferably positioned side by side so that the focal setting indication can be easily set by the camera operator to match the range indication for the desired degree of focus. The operator can manually operate the lens focusing system to match or near match these indications to obtain the desired degree of focus.

For the purpose of better illustrating the operation of the camera and its combined automatic and manual focusing system, the camera is illustrated as filming a scene having a pair of moving figures or subjects 13 and 14. A primary photographic subject 13 is shown more distant than a closer more dominant subject 14 that is dominating in both position and size. For the purposes of illustration it is understood that the subjects are in motion with the primary photographic subject 13 being the primary focus of attention. For this reason, the primary focus of the camera will be predominantly on this subject 13 which in the illustrated scene is overshadowed by a secondary subject 14.

For the sake of convenience, the present invention will be described in connection with and as a modification of the inventor's prior focusing systems disclosed in U.S. Pat. Nos. 4,601,557 and 4,534,629, both of which are incorporated herein by reference as though fully set forth. In accordance with the primary aspect of the invention, the focusing system has a range finder 17 that operates on the principle of a radar and generates and transmits a first radio signal 18 consisting of a sequence of high frequency short time duration pulses which are transmitted in a direction toward the scene to be shot from the range finder antenna. The principal photographic subject 13 has a miniature transponder 19 mounted on or carried in the clothing which receives the first radio signal 18 and returns a signal. The transponder 19 responds to the first radio signal 18 by generating and transmitting a second radio signal 20 which is distinctive from the first radio signal 18. The rangefinder 17 and its associated receiving system receives the second radio signal 20 and processes it in a microprocessor in the focusing system to measure the time interval between the transmittal of the first radio signal 18 and the receipt of the second radio signal 20. The microprocessor translates the time interval measurement into a range signal which represents the distance between the lens and the primary photographic subject 13. This range signal is then utilized in the automatic mode for causing the servo or drive motor of the lens to adjust the lens 12 to the proper focus. In the manual mode the range signal provides a visual indication of the range to enable the operator to match the lens setting indication to it as closely as he desires. The focusing system acts somewhat in the manner of a ranging radar with the operation being on the order of between from about 3 meters to about 100 meters or more depending on the focusing requirements of the lens in use.

The present system can utilize any form of ranging system including but not limited to sonic, light, IR or radio waves. It can also be incorporated in any type of motion picture camera, including film, video tape, disc or card with either optical or digital systems for focusing. It is understood that the illustrated camera 10 includes the usual shutter control, light control and other necessary controls which will not be specifically described herein.

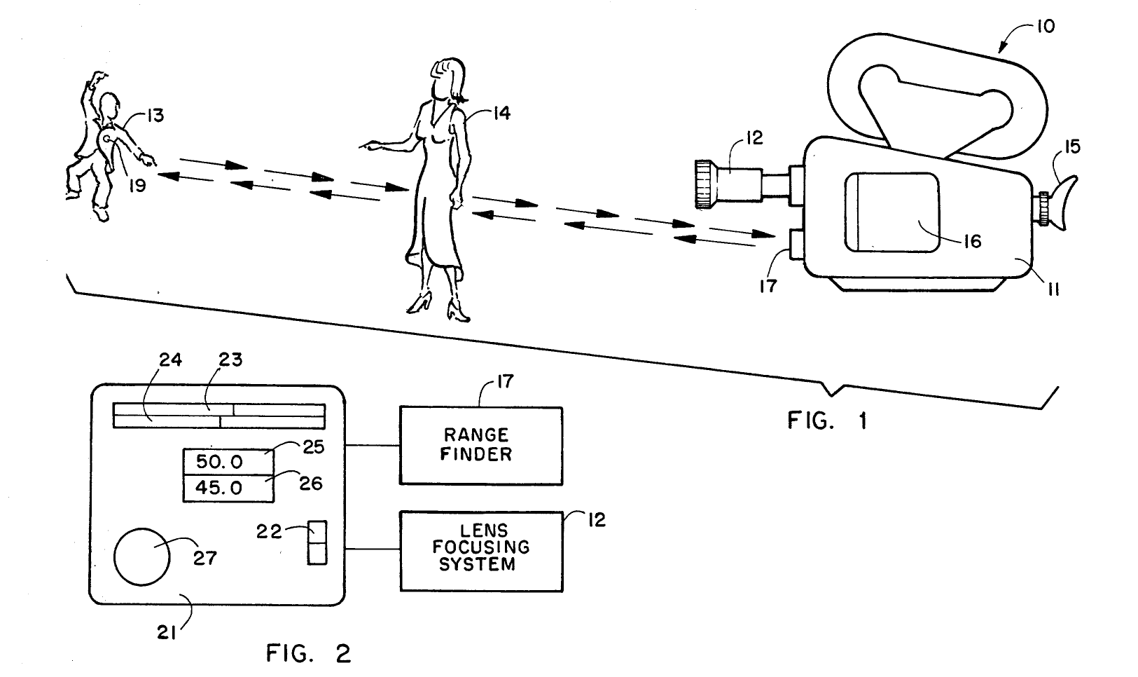

Referring to FIG. 2, the system in its simplest form is diagrammatically illustrated in block diagram and includes a range finder 17, lens focusing system 12 and a manual control and indicator panel 21. The range finder can be any form such as ultrasonic, light beam, infrared, radio signal and the like. The lens focusing system has a driver such as an electric motor for adjusting the focus of the lens. The manual control and indicator panel or unit includes at lest one indicator 23 for indicating the range and one indicator 24 for indicating the lens focus position. The panel further comprises a switch 22 to switch between automatic focusing and manual focusing and an actuator such as a rotary knob 27 for manual input to adjust the focus of the lens. Preferably it also includes numerical indications 25 and 26 of the range and lens setting.

Control panel 21 may be incorporated into the viewing screen now available on most current cameras, directly attached to the camera case or it may be a hand held device that is wireless or connected by one or more conductors to the camera. Variations may include incorporating the indicators in the view screen and positioning the switch and control knob at other locations on the camera or associated equipment. In the illustrated embodiment the primary indicators are moveable lines or strips which may be a strip of lights or LEDS responding to show a respective value. When the outer ends of the two strips are even the range and focus are in sinc or matched and the lens is properly focused. Manual control wheel or knob 27 enables the operator to adjust the lens setting when in the manual mode to match the range indicator as closely as he desires at his option.

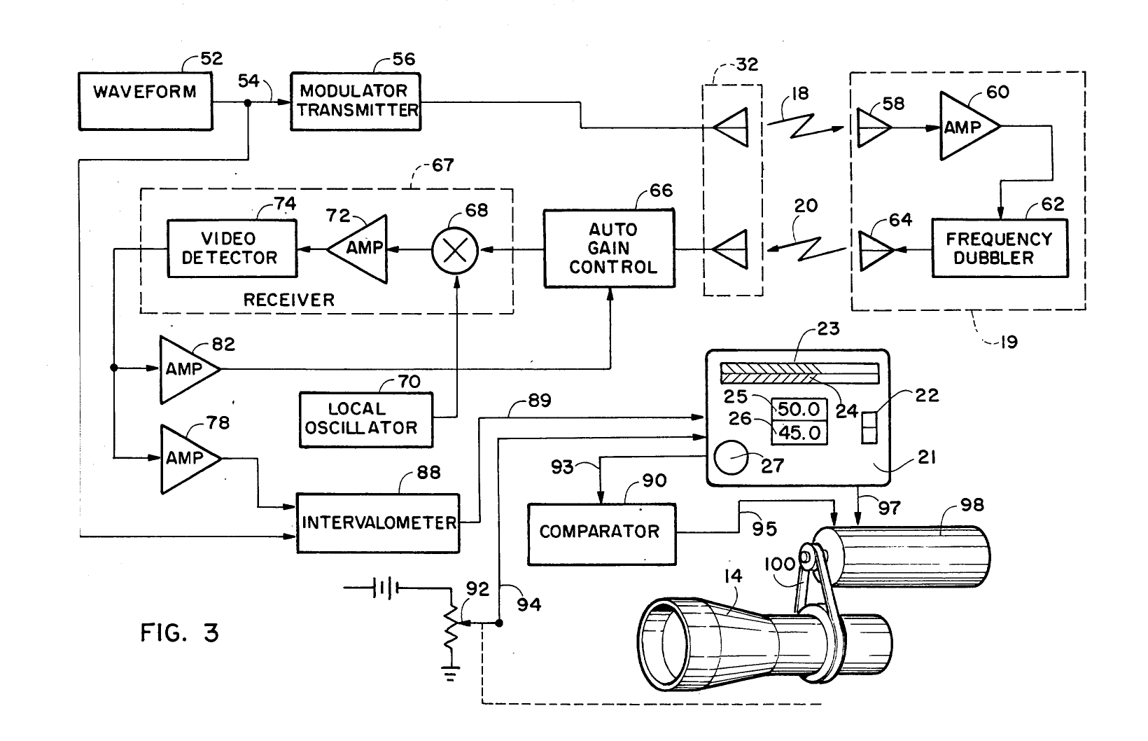

Referring to FIG. 3, a detailed block diagram of one embodiment of the system is illustrated which embodies one form of the automatic focusing system of the inventors prior patents. The illustrated system comprises a waveform generator 52 which preferably generates pulses on the order of about 10 nanoseconds in length at about a 100 kilohertz repetition rate, with the pulses being transmitted by a conductor 54 to a modulator-transmitter 56. The modulator-transmitter 56 produces pulses of high frequency (e.g. microwave) radio energy whose duration and repetition rate is determined by the waveform generator 52. This short duration of pulses is desirable because of the short distances of operation of the camera. The short duration of pulses enables the complete transmission of each pulse before it is received back at the camera. In essence the signal duration must not exceed the minimum time delay for the round trip to the subject and back to the camera. It should be noted that the radio waves travel at the speed of light.

A range of frequency on the order of about 10.5 GHz to about 21 GHz is suitable for this application. The frequency of about 10.5 GHz is preferably selected for such a system because it is infrequently used for terrestrial communication links, and accordingly, easier to facilitate FCC licensing. Also, the propagation distances of interest are of such short range that atmospheric absorption losses within this frequency band are not significant. The modulator-transmitter 56 transmits the first radio signal 18 by way of an antenna 32 of the range finder 17 and such signal 16 is received by the transponder 19 on the subject of interest 13.

The transponder 19 carried by the primary photographic subject 13 is a miniature electronic device on the order of the size of a credit card or pack of cigarettes or somewhat similar. The transponder includes an antenna 58 which receives the signal and an amplifier 60 that amplifies it and codes it by doubling the frequency to generate the second or return radio signal. The received first radio signal is amplified by the amplifier 60 and fed into a frequency doubler 62, which doubles the frequency to 21 GHz retransmits it back through an antenna 64 as the second radio signal 44. Other forms of coding may be utilized. The second radio signal 44 is received by the antenna 32 and fed through an attenuator 66 for automatic gain control of the signal.

The received second radio signal is then demodulated in a receiver 67 by first combining it in a mixer 68 with a signal from a local oscillator 70 to provide the received signal at an intermediate frequency. The signal from the mixer 68 is then amplified by an amplifier 72 and transferred through a video detector 74. The detected signal is then carried by a conductor 76 and amplified in an amplifier 78 before being fed into an intervalometer 80. The detected signal also is amplified by an amplifier 82 and, via line 84, is utilized as an automatic gain control signal for the automatic gain control 66 which includes the PIN diode attenuator.

The intervalometer 88 measures the time difference between transmission of the first signal and the receipt of the second signal from the subject. The second signal is passed through the amplifier 78 to the intervalometer. A signal of the transmission of the first signal is generated when the first signal is transmitted and is transmitted by way of conductor 86 from the transmitter to the intervalometer. The intervalometer 88 measures the time difference for establishing a time between the transmittal of the first radio signal 40 and the receipt of the second radio signal 44 from the primary photographic subject 34. A range signal is generated by the intervalometer based on the time difference, such as a proportional analog voltage, that is transmitted by conductor 89 to the control and indicator panel 21. This range signal has a value representing the range that is shown by indicator 23.

The lens focus setting is sensed by suitable means such as a potentiometer 92 and a signal is transmitted by way on conductor 94 to the control and indicator panel 21. The lens focus signal setting represents a value that is indicated by indicator 24. The signal indicators 23 and 24 are positioned so that the values thereof can be easily compared visually by the operator.

The lens focusing system can be selectively switched by switch 22 back and forth between manual mode and automatic mode. In the manual mode, the operator can compare the signals on indicators 23 and 24 and operate manual control knob 27 to adjust and match the lens focus setting to the range setting to the degree that he desires. A lens focus signal is transmitted from the control unit 21 by way of conductor 97 to the lens focus drive motor 98 to set the focus of the lens. Thus, he can manipulate the lens setting to fade in or out of the scene or to maintain the scene in or out of focus to any degree desired.

In the automatic lens focusing mode, the range from the lens 14 to the primary photographic subject and the lens focus setting are transmitted through the control unit 21 by way of conductor 93 to the comparator 90. The comparator 90 compares these signals for generating a difference signal or a signal proportioned to the difference between the two signals. The comparator 90 responds to any difference signal by generating a focusing signal which is transmitted by way of conductor 95 to a servo motor 98, which is coupled by a gear drive mechanism 100 for driving the focusing ring of the lens 14. This system, in the automatic mode, provides a continuous automatic monitoring and focusing of the lens system 14 of the camera in response to movement of the primary photographic subject which carries the transponder 19.

The modulator-transmitter 56 may be obtained on special order from Varian Associates in San Mateo, Calif. The operating frequency of the modulator-transmitter should be in the range of from 10 to 36 GHz. The pulse length is on the order of 10 nanoseconds or less. Such short-pulsed high radio frequencies are required to permit a reasonable number of radio frequency cycles within the pulse in order to define a realistic radio frequency. Also, microwave frequencies will permit the use of a physically small antenna which demonstrates significant gain and narrow beam width. The pulse repetition rate can be much higher than normal radar systems because of the short range. Such high repetition rate can compensate for short pulses in terms of average power which affects radar sensitivity. The components of the system are constructed of solid state components.

The transponder 19 is of a monolithic construction with simple antennas 58 and 64 such as a printed circuit type. The transponder 19 includes a receiving antenna 58, amplifier 60, frequency doubler 62 and a transmitting antenna 64. It receives the pulses, amplifies them, doubles the radio frequency and re-radiates the second radio signal 44 on the antenna 64. The size of the transponder 19 is of such order that it can be readily concealed in the outer clothing disguised as jewelry, or other items such as a belt buckle, sheriffs badge, or the like. Such devices can be obtained on special order from Honeywell of Santa Barbara, Calif.

The antenna 32 is a dual-frequency antenna having a rectangular horn antenna, as illustrated and described in my prior patent '557. The gain of the antenna 32 is typically 20 dB at X-band and 24.5 dB at K-band. Matching is improved through the use of an adjustable stub 9 not shown).

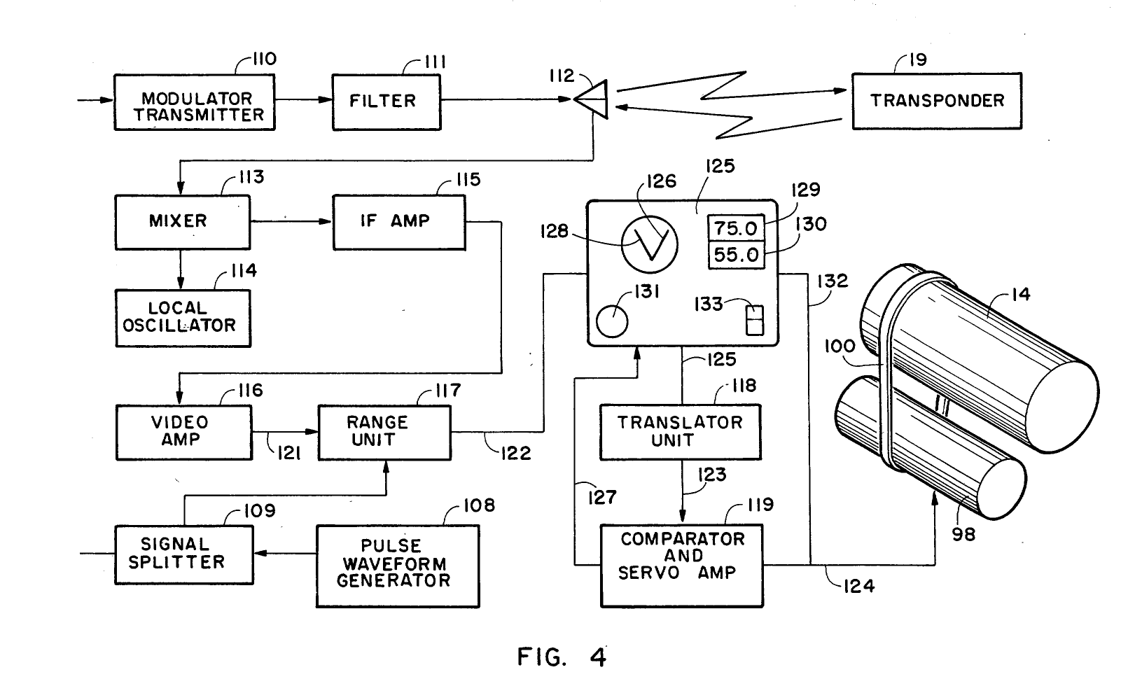

Referring to FIG. 4 an alternative exemplary preferred embodiment of the combined automatic and manual focusing system in accordance with the present invention is illustrated. This embodiment also combines or incorporates an embodiment of one of the automatic focusing systems of the inventor's prior patent referenced above. As illustrated in FIG. 4, the overall system comprises a transponder 19, a pulse waveform generator 108, a signal splitter 109, modulator-transmitter 110, a filter 111, a microwave antenna 112, a mixer 113, a local oscillator 114, an intermediate frequency (IF) amplifier 115, a video amplifier 116, a range unit 117, a translator unit 118, a comparator and servo amplifier circuit 119, a manual control and indicator unit 125 a servo motor 98 and a gear drive mechanism 100.

The pulse waveform generator 108 generates a pulsed waveform as described in the prior embodiment that is provided by the signal splitter 109 to both the modulator transmitter 110 and the range unit 117. The modulator-transmitter 110 modulates the pulsed waveform for transmission and provides a radio signal at an X-band frequency of 10 GHz to the microwave antenna 112, via the filter 111, which attenuates any higher harmonics of the 10 GHz radio signal that may be present in the signal provided by the modulator-transmitter 110. The microwave antenna 112 transmits the 10 GHz radio signal toward the primary photographic subject carrying the transponder 19. The transponder 19 responds to receipt of the 10 GHz radio signal by doubling the frequency to generate a 20 GHz radio signal in the K-band and transmitting the same back toward the camera.

The microwave antenna 112 receives the 20 GHz radio signal from the transponder 19 and provides such signal to the mixer 113. The mixer 113 mixes the received signal from the antenna 112 with a signal from the local oscillator 114 to provide the received signal at an IF frequency to the IF amplifier 115. The video amplifier 116 is connected in series with the output of the IF amplifier 115 and provides a return signal on line 121 to the range unit 117.

The range unit 117 measures the time interval between the transmittal of the 10 GHz radio signal and the receipt of the 20 GHz radio signal by processing the return signal on line 121 and a transmit signal received on line 120 from the pulse waveform generator 108 via the signal splitter 109. The range unit 117 generates a range that is representative of the distance between the camera lens and the subject signal and transmits it via line 122 indicator and manual control unit 125. The range signal activates an indicator 126 in the form of a moveable hand or needle that provides a visual indication of the range.

The comparator and servo amplifier unit senses the setting or focal position of the lens and generates a lens position or setting signal that is transmitted via conductor 127 to the manual control and indicator unit 125. An indicator 128 responds to the lens setting signal to move to a position indicative of the lens focal position. The indicator arms or needles pivot about a common point and when aligned, the camera is focused on the subject. The manual control also preferably has numerical indications 129 and 130 of the range to the subject and the position of the lens respectively. The camera operator can use these visual indicators when in the manual mode to adjust the lens setting by means of a control knob 131. A lens adjusting or positioning signal is transmitted from the control unit via conductor 132 to the lens drive motor 98 when in the manual mode. A switch 133 enables the operator to switch the lens focusing system between the automatic and the manual mode of operation.

When the lens focusing system is in the automatic mode of operation the range signal from the range unit 117 is transmitted through the manual control unit and via line 134 to the translator unit 118. The translator unit 118 processes the range signal on line 134 to provide a focusing signal on line 123 to the servo amplifier 119. The servo amplifier 119 responds to the focusing signal on line 123 by providing a drive signal on line 124 to drive the servo motor 98 to adjust the focus of the lens 14 via the focusing ring drive mechanism 100 so that the lens focus setting matches the focusing signal.

The components of the system are available from various sources as identified in applicant's prior patents. A suitable pulse waveform generator 108 is a Picopulse Pulse Labs Model 2000-03 pulse generator. Output pulses are generated by the discharge of a 50 ohm delay line through an avalanche transistor and a 50 ohm load. As used in the system, a 140-inch long delay line produces pulses of 36 nanosecond duration. The repetition rate of the pulse generator is adjusted to 100 KHz. The pulse rise and fall times are less than 500 picoseconds. The nominal 50 volt output pulse is reduced with a 20 dB HP 33340C attenuator and subsequently divided into two five volt amplitude channels with a Merrimac Type PD-20-17 signal splitter. One of these channels drives the modulator/transmitter and the other produces the initial trigger required by the range-measuring unit.

The modulator/transmitter 110 is a Type VXC95435, manufactured by Varian's Solid State Microwave Division. It includes an impedance-matching amplifier and bias supply (the modulator), a 20 GHz IMPATT RF oscillator (the transmitter), an output circulator and a DC-to-DC inverter. The output of the modulator/transmitter produces a 3.5 watt peak power pulse at X-band. The inputs required are a five volt positive keying pulse and 24 volt DC power.

The antenna for the range finding unit is a dual-frequency antenna having a rectangular horn antenna, as in the prior embodiment. The gain of the antenna is 20 dB at X-band and 24.5 dB at K-band. Matching is improved through the use of an adjustable stub. To eliminate residual 21 GHz second-harmonic and higher frequency signals—generated by the transmitter-modulator from entering the receiver, a Model FBP-1014 band-pass filter 111 supplied by Western Microwave, is connected between the transmitter-modulator 56 and the transmitter port. Received 20 GHz signals, entering the antenna horn section, pass through the first waveguide section without attenuation, thence through the second waveguide section without substantial attenuation. The length of the second waveguide section was selected to provide 100 dB of isolation from the 10 GHz radio signals from the transmitter-modulator 56. The transponder 19 is constructed as described above with reference to FIG. 3.

A suitable mixer 113 is an RHG Electronics Model DMS 21 J05GK. The local oscillator 114 may be a Central Microwave Model 610 local oscillator. The IF amplifier may be an RHG Electronics Model ICL 750-30H. A suitable video amplifier is a Comlinear Corporation Model E103N. The bandwidth of the IF amplifier 115 is a nominal 500 MHz and provides a logarithmic response over a 65 dB range. The video amplifier 116 has a DC to 150 MHz bandpass. The IF amplifier 115 includes a second detector. The 26 dB gain of the video amplifier 116 produces a signal of sufficient amplitude for the range unit 117 to detect.

The range unit 117 accepts a “transmit” signal on line 120 from the pulse waveform generator 108 and a “return” signal on line 121 from the video amplifier 116 and provides a range signal on line 122 having a voltage that is linearly proportional to the time interval between them. Since the characteristics of the Varian modulator/transmitter 110, together with the delay in the interconnecting cables, produces a delay of approximately 80 nanoseconds between the rise of the keying pulse and the rise of the output RF pulse, an offset bias is provided at the output of the range unit 117 to compensate for this fixed delay.

The basic operation of the range unit 117 is one in which the start of the two independent ramp (sawtooth waveform) signals (i.e., uniformly increasing with time) are triggered respectively by the start of the transmit signal pulse on line 120 and the start of the return signal radar echo pulse received on line 121. At some time after the initiation of these two ramp signals, the range unit 117 samples the voltage difference between the two ramp signals and holds such difference, which is proportional to the interpulse time delay, for presentation at the output of the circuit as a DC (or slowly varying) voltage range signal on line 122. By expressing the time interval as the difference between the simultaneous voltages of the two ramp signals generated by identical circuits, non-linearities due to temperature effects, component aging or other related matters are practically eliminated. Furthermore, since the duration of the two ramp signals can be long compared to the interpulse interval, the information-bearing voltage difference can be sampled at a time which is sufficiently delayed form the time of initiation that the effect of transient ringing can be avoided.

Four time intervals must be taken into account in the operation of the system. The first is the radar delay interval which is the value to be determined, i.e., from approximately 10 to 1000 nanoseconds. The second interval of importance is the radar interpulse interval which is the inverse of the radar repetition rate. This interval is a nominal ten microseconds and only has bearing on the range unit 117 insofar as the sampling functions of the latter must be complete before the next transmit pulse is generated. The third interval of importance is the delay between the start of the second ramp signal initiated by the return signal radar echo pulse and the time at which the sample is taken of the voltage difference between the first and second ramp signals. A nominal value of 500 nanoseconds has been selected for this delay. Finally, a ramp duration of two microseconds has been selected to provide the maximum slope in volts per microsecond which is consistent with TTL (five volt) operating levels and the maximum system operating delay of one microsecond.

Further specific details of, the range unit 117 and the specific components and the operation thereof are more fully described in detail in applicants prior patents mentioned above. The range unit as described may be selectively operated in one of three different modes, as determined by the manual setting of the mode selection unit for the range unit. These three modes are a “normal” mode, a “lock” mode and an “auto/lock” mode. In the normal mode, the mode selection unit continuously provides an enabling signal to a clock trigger unit. The function of the clock trigger unit is to provide a clock trigger signal on line for triggering the sample clock generator to provide a sample clock signal to a sample and hold unit and a sample clock signal to a translator unit. The sample and hold unit samples the difference signal in response to the sample clock signal and holds the value of the sampled signal until the next clock sample clock signal is provided.

The clock trigger unit provides clock trigger signal in response to the first to be received of either a pulse derived from the return signal received by the second sawtooth waveform generator or a pulse derived from the transmit signal pulse received by the first sawtooth waveform generator and then delayed by a delay unit by a predetermined time corresponding to at least the hyperfocal distance of the lens.

The range unit is operated in the lock mode when it is desired to lock the lens at its then existing focal length setting, such as in the event the transponder 19 (and thereby the primary photographic subject 34) is momentarily obscured from view by the system antenna 112. The criterion for the “lock” function is the amplitude of the return signal. When the mode selection unit is placed in the lock mode an inhibiting signal is provided to the clock trigger unit, thereby inhibiting the triggering of the sample clock generator and maintaining the range signal at its existing value.

When the mode selection unit is placed in the auto/lock mode, an inhibiting signal is provided to the clock trigger unit until a return signal pulse of at least a predetermined minimum amplitude is detected by the return signal detector, and then an enabling signal is provided. The relative timing of the signals provided to the clock trigger unit, is such that the enabling signal is received prior to either of the signals unless the selected photographic subject is beyond the hyperfocal distance of the lens 12. Accordingly, whenever no second radio signal is received between successive transmittals of the first radio signal, the clock trigger unit is inhibited and the existing value of the range signal is maintained.

The transmit signal pulse corresponds to the start of the radar interpulse interval; and the return pulse corresponds to the end of this interval. The interpulse interval is proportional to the distance to the transponder 19 from the camera focusing system.

The sample and hold unit includes a Model HTC-0500, a high-speed sample-and-hold device and a 600 nanosecond one-shot. The unit is normally in the “hold” mode and switches briefly to the “sample” mode for each measurement update at approximately a 1 KHz rate as controlled by the sample clock signal. The sample period starts at the beginning of the return signal pulse charge cycle, and continues for 600 nanoseconds. During this interval, the signal tracks any variations in the difference signal. When the sample and hold unit switches back to the hold mode, the signal is held at the value at that time and remains constant until the next measurement.

The output amplifier provides for the output zero and scaling adjustments required for interface with the following translator unit 118. The zero (or offset) adjustment includes the important compensation for the earlier-mentioned delay occasioned by functions in the modulator/transmitter 110. The output amplifier gain adjustment is placed at the input of the amplifier stage to isolate the effects of gain adjustment from offset adjustments.

In order accommodate an operating situation in which the selected photographic subject 34 bearing the transponder 19 may momentarily be obscured from the antenna by an object which blanks the return of the second radio signal, the operator operates the mode selection unit to place the range unit in the auto/lock mode, wherein the signal on line and thereby the camera focus are locked at values corresponding to the last range that was detected. When the antenna again picks up the returned second radio signal, the range unit automatically switches into the normal automatic tracking routine provided in the normal mode of operation.

Alternatively, the operator can also switch the mode selection unit to place the range unit in the lock mode, wherein the range signal and thereby the camera focus are maintained at their existing values independently of the radar operation of the focusing system.

In the normal mode, the camera focus will default to the hyperfocal distance in the absence of returned second radio signal. This feature allows for situations in which the subject approaches from (or recedes to) a distance which is beyond the radar system operating range, which equals the hyperfocal distance of the camera.

The clock trigger unit responds to the delayed pulse only if no second radio signal is received by the antenna within a predetermined time after transmittal of the first radio signal corresponding to at least the hyperfocal distance of the camera lens. Since this delayed pulse is timed to occur at a later time than the latest expected true return, the range signal will represent the hyperfocal distance of the camera lens.

The voltage-level output of the range signal is linearly proportional to the distance to the transponder 19 as measured by the radar elements of the system. However, it is characteristic of lenses that the position of the lens (usually the rotational position of the lens focusing ring) is inversely proportional to object distance (range). In the case of complex lenses, typical of modern designs including zoom lenses, there may also be deviations from a simple inverse relationship. To accommodate the difference between the proportional and inversely proportional relationship, the function of a cam must be invoked, with a specific functional cam being required for each different lens type. In this preferred embodiment of the system of the present invention, this cam function is provided through the application of digital processing by the translator 118.

The translator unit includes an input buffer amplifier, and analog-to-digital (A/D) converter, a latch, a programmable read-only memory (PROM), a digital-to-analog (D/A) converter, an output amplifier and a divider.

In brief, the range-proportional analog range signal from the range unit is first digitized by the A/D converter, then processed through a stored digital look-up memory in the PROM that is specific to the lens in use, and which produces an output signal that corresponds to a (generally) inverse relationship to its input signal. The D/A converter then re-converts this processed digital output signal to an analog signal and the output amplifier conditions this analog signal to provide a focusing signal to the servo amplifier 119 (FIG. 4). The physical form of the PROM is a typical integrated-circuit chip, which is interchangeable and may be replaced in the translator unit to correspond to the particular lens system 14 that is being used. The contents of the PROM 155 are derived from careful measurements of each individual lens in which electrical signals are recorded for each of a series of optically-determined focus positions for various object distances. For redundancy, these distances can be made to coincide with the focus ring markings if the latter agree closely with actual object distance. In practice, a limited, but adequate, number of these measurements are made, a smooth graphical (or computer curve-fitted) interpolation of the points is constructed and all intermediate points taken from this construction.

By its nature, digital processing produces a set of step-wise, rather than continuous, variations. However, by selecting a suitable large number of steps, an arbitrarily close approximation can be made to a continuous variable. In the system, a 10 bit PROM has been selected which provides 1023 steps (1024 values). Based on the determined hyperfocal distance of a sample 120 mm, 16 mm-format lens, a working maximum range of 40 meters was selected for the system. Accordingly, each of the 1023 steps in range is 0.0391 meters (1.54 inches) in extent. Tests with this lens show that smooth focusing is achieved—with an f2.2 stop—at ranges down to approximately two meters (6.56 feet).

Referring again to FIG. 4, the servo amplifier circuit 119 drives the servo motor 98 to bring the focus ring setting to match the range input. Generally, the servo amplifier circuit 119 includes a comparator circuit, a driver amplifier and a three-turn potentiometer which is used as a position feed-back source. The signal from the feedback potentiometer is matched against the focusing signal on line 123 by the comparator circuit in the servo amplifier circuit 119. The output of this comparator circuit is provided to the driver amplifier which drives the servo motor 98 to a null position. This technique eliminates the need for linearity in the motor system and allows for optimization of the motor servo loop dynamics. It should be noted that any non-linearities in the feed-back potentiometer are calibrated out in the process of determining the exact values for the translator PROM. The servo motor 98 is mounted on the camera lens and actuates the lens focus ring through a spur and ring-gear combination. The ring gear is precision-machined to a tight clamped fit on the lens focus ring. The motor-to-gear ratio is 1:6.

The differential amplifier in the servo amplifier circuit 119 senses the difference voltage between the radar-generated range information and the signal from the position feed-back potentiometer and drives the servo motor to null this difference in the automatic mode. A following amplifier stage provides additional gain. The gain of this stage is adjusted, in accordance with a selected value of feed-back, to produce a maximum running rate for the servo motor 98 without tendency for overshoot.

The camera focusing system as illustrated and described herein solves the problem of an operator desiring more control over the focus of a camera than normally available by automatic focusing cameras and the usual combined automatic manual focusing systems. The solution was to give them the option to move from fully automatic focusing to manual focusing, using the range finder as a range finder when the shots required a focal setting which is slightly different then the actual range as described by the range finder. The approach that works is to have a visual representation of the range setting of the lens which can be matched to a corresponding visual representation of the actual range which is supplied by the radar. Examples include a double needle meter with one needle representing the radar range and the other representing the lens focus setting, the same using moving L.E.D. indicators or the same function using a very small computer monitor. SO as the radar range indicator travels the operator can manually focus by matching the lens focus position indicator to the radar range indicator. The focus ring on the lens is operated by a motor directed by the operator.

Certain preferred embodiments have been described above. It is to be understood that latitude of modification and substitution is intended in the foregoing disclosure, and that these modifications and substitutions are within the literal scope, or are equivalent to the claims that follow. Accordingly, it is appropriate that the following claims be construed broadly and in a manner consistent with the spirit and scope of the invention herein described.

What is claimed is:

1. A camera lens focusing system with an automatic mode and a manual mode for focusing a camera on a moving photographic subject, comprising:
an adjustable focus lens having a driver for focusing the lens on a photographic subject;
a lens position detecting device to detect a focus position of the lens;
a distance detecting device to detect a subject distance from the lens and generate a range signal representation of the range to the photographic subject:
automatic actuating means responsive to the range signal for activating the driver to adjust the position of the lens to focus on the photographic subject;
an indicating device responsive to said range signal for activating a first indicator indicative of the focal point of said subject and responsive to the lens setting for activating a second indicator indicative of the range setting of the lens;
manual actuating means responsive a manual input to activate the driver to focus the lens; and
a switching device to switch between the automatic mode and the manual mode.

2. A lens focusing system according to claim 1, wherein said first indicator and the second indicator comprise a pair of adjacent parallel moveable lines.

3. A lens focusing system according to claim 1, wherein the first indicator and the second indicator comprise a pair of adjacent parallel rows of lights . . .

4. A lens focusing system according to claim 3, wherein the rows of lights are LEDS.

5. A lens focusing system according to claim 1, wherein the first indicator and the second indicator comprise a pair of needles moveable from a common position on a scale.

6. A lens focusing system according to claim 5, wherein said pair of needles pivot about a common axis.

7. A lens focusing system according to claim 1, wherein the distance detecting device comprises a radar distance measuring device.

8. A lens focusing system according to claim 7, wherein the radar distance measuring device includes at least one transponder.

9. A lens focusing system according to claim 8, wherein the radar distance measuring device transmits of about 10 nanoseconds in length at about a 100 kilohertz rate.

10. A lens focusing system according to claim 8, wherein the radar distance measuring device operates within a frequency range of about 10.5 GHz to about 21 GHz.

11. A system for automatically and manually focusing a camera, said system comprising
first radio signal generating and transmitting means carried by the camera to be focused for generating and transmitting a first radio signal at a first frequency toward a photographic subject;
second radio generating and transmitting means carried by the photographic subject and responsive to said first radio signal for generating and transmitting a second radio signal at a second frequency that is significantly higher than the first frequency;
a microwave antenna carried by the camera for receiving the second radio signal and included in the first transmitting means for radiating the first radio signal;
means for measuring the time interval between the transmittal of the first radio signal and the receipt of the second radio signal and for generating a range signal that is representative of said measurement;
means carried by the camera for adjusting the focus of the camera in response to the range signal
a switching device to switch between the automatic mode and the manual mode
an indicating device responsive to said range signal for activating a first indicator indicative of the focal point of said subject and responsive to the lens setting for activating a second indicator indicative of the range setting of the lens; and
manual actuating means responsive a manual input to for activating the driver to focus lens.

12. A lens focusing system according to claim 11, wherein said first indicator and the second indicator comprise a pair of adjacent parallel moveable lines.

13. A lens focusing system according to claim 11, wherein the first indicator and the second indicator comprise a pair of adjacent parallel rows of lights.

14. A lens focusing system according to claim 11, wherein the first indicator and the second indicator comprise a pair of needles moveable from a common position on a scale.

15. A lens focusing system according to claim 14, wherein said pair of needles pivot about a common axis.

16. A method of selectively automatically and manually focusing a camera, said method comprising the steps of;
generating a first radio signal and transmitting the first radio signal from the camera to be focused toward a photographic subject;
responding to said first radio signal by generating a second radio signal and transmitting the second radio signal from the photographic subject;
receiving the second radio signal at the camera;
measuring the time interval between the transmittal of the first radio signal and the receipt of the second radio signal and generating a range signal that is representative of said measurement;
adjusting the focus of the camera in response to the range signal in an automatic mode;
switching to a manual mode of focusing;
providing a first indicator in response to the range signal of range to the subject;
providing a second indicator of the focus setting; and
manually adjusting the second indicator to the first indicator to adjust the focus setting to a desirable match with the range of the subject.

17. A method of focusing a camera according to claim 16, wherein the steps of:
providing a first indicator comprises providing a first movable line: and
providing a second indicator comprises providing a movable line adjacent to and parallel to said first line.

18. A method of focusing a camera according to claim 16, wherein the steps of:
providing a first indicator comprises providing a first movable row of lights: and
providing a second indicator comprises providing a second movable row of lights adjacent to and parallel to said first row.

19. A method of focusing a camera according to claim 16, wherein the steps of:
providing a first indicator comprises providing a first movable needle: and
providing a second indicator comprises providing a second movable needle adjacent to and moveable from a common position on a scale to said first needle.

20. A method of focusing a camera according to claim 19, wherein the steps of:
providing a first movable needle: and
providing a second movable needle comprises providing said pair of needles pivot about a common axis.
